(19) United States
(12) Patent Application Publication
(10) Pub. No.: US 2012/0181245 A1
(43) Pub. Date: Jul. 19, 2012

(54) NURSING BOTTLE NIPPLE AND AIR-VENTING SYSTEM

(76) Inventor: Wai Leung Lam, Hong Kong (HK)

(21) Appl. No.: 13/005,552

(22) Filed: Jan. 13, 2011

(51) Int. Cl. A61J 9/04

(52) U.S. Cl. 215/11.5

(57) ABSTRACT

The nursing bottle nipple has a nipple portion integrally formed with an air-venting tube extending to the bottom of the bottle so that air can enter the bottle without mixing with the milk inside the bottle. An air inlet of the air-venting tube is integrally formed on the base portion of the nipple so that it cannot be covered by the collar that holds the nipple onto the neck of the bottle. A nursing bottle air-venting system is also disclosed.

### FIELD OF PATENT APPLICATION

The present application relates to a nursing bottle nipple and a nursing bottle air-venting system.

### BACKGROUND

Traditional nursing bottles include a nursing nipple held securely to the neck of a bottle by a collar. However, it is difficult for an infant to drink liquid such as milk from these traditional nursing bottles because there are no openings that can allow air to enter these nursing bottles. It is appreciated that air must enter the nursing bottle to replace the milk inside the nursing bottle so that the milk can smoothly flow out of the nursing bottle without difficulties. These traditional nursing bottles have been known to cause swallowing of air which is attributed to colic and spit-up in bottle-feeding infants. Using these traditional nursing bottles may increase the number of onset of otitis media in infants.

Nursing bottles with air guiding assemblies are known in prior art. The air-guiding assembly of these nursing bottles is usually complicated in structure and has one or more air passages formed around the annular mounting flange of the nipple. These air passages are therefore substantially covered up by the collar that holds the nipple to the neck of the bottle. Therefore, it cannot be sure whether these air passages can allow air to properly enter the bottle after the collar is tightly screwed onto the neck of the bottle.

Nursing bottles with tubes for admission of air are also known in the art. However, the tube of these nursing bottles is short and, when in use, causes air entering the bottle to mix with the milk inside the bottle.

There is a need to provide an improved nursing bottle nipple and air-venting system to alleviate the disadvantages of the existing nursing bottles.

The above description of the background is provided to aid in understanding a nursing bottle nipple and air-venting system, but is not admitted to describe or constitute pertinent prior art to the nursing bottle nipple disclosed in the present application.

### SUMMARY

According to one aspect, there is provided a nursing bottle having an air-venting system and including (i) a container having an opening; (ii) a nipple having a top apertured nipple portion and a generally bowl-shaped base portion adapted to couple to the opening of the container; (iii) an air-venting tube extending from the base portion into the container, the tube having an open end coupled to and in air communication with an air inlet formed on the base portion of the nipple, and an opposite closed end disposed near a bottom of the container; and (iv) at least one slit formed on the air-venting tube at the closed end thereof. Suction on the apertured tip portion of the nipple of the container held in an inverted and tilted nursing position causes a drop of pressure of the air at the bottom of the container, thereby drawing air from the outside of the container, into the air inlet, along the air-venting tube, through the at least one slit, and to the bottom of the container.

In one embodiment, the at least one slit has a length sufficient to permit air to force the at least one slit open and enter the container, and yet prevent liquid from leaking out of the container through the at least one slit. The at least one slit may extend longitudinally along the air-venting tube. In one embodiment, the nursing bottle includes two slits which may be formed on two opposite sides of the air-venting tube respectively.

In one embodiment, the base portion of the nursing bottle has an annular flange for engaging with a neck of the container, and the air inlet is formed on the base portion adjacent to the annular flange. The air-venting tube can extend downwardly from the base portion generally parallel and adjacent to a sidewall of the container. The closed end of the air-venting tube may be located near the bottom of the container adjacent to a sidewall thereof. The air-venting tube may be integrally formed with the nipple. The nipple and the air-venting tube may be made of rubber.

According to another aspect, there is provided a nursing bottle nipple including (i) a top apertured nipple portion and a generally bowl-shaped base portion adapted to couple to an opening of the nursing bottle; (ii) an air-venting tube adapted to extend from the base portion into the nursing bottle, the tube having an open end coupled to and in air communication with an air inlet formed on the base portion, and an opposite closed end disposed near a bottom of the nursing bottle; and (iii) at least one slit formed on the air-venting tube at the closed end thereof.

Although the nursing bottle nipple and air-venting system disclosed in the present application is shown and described with respect to certain embodiments, it is obvious that equivalents and modifications will occur to others skilled in the art upon the reading and understanding of the specification. The present application includes all such equivalents and modifications, and is limited only by the scope of the claims.

### BRIEF DESCRIPTION OF THE DRAWINGS

Specific embodiments of the nursing bottle nipple and air-venting system disclosed in the present application will now be described by way of example with reference to the accompanying drawings wherein:

FIG. 1 is a top perspective view of an integrated nipple and air-venting tube of a nursing bottle according to an embodiment disclosed in the present application;

FIG. 2 is a bottom perspective view of the integrated nipple and air-venting tube of FIG. 1;

FIG. 3 is another bottom perspective view of the integrated nipple and air-venting tube of FIG. 1;

FIG. 4 is a side view of the integrated nipple and air-venting tube;

FIG. 5 is a cross sectional view of the integrated nipple and air-venting tube; and

FIG. 6 is a perspective view of an inverted and tilted nursing bottle with the integrated nipple and air-venting tube.

### DETAILED DESCRIPTION

Reference will now be made in detail to a preferred embodiment of the nursing bottle nipple and air-venting system disclosed in the present application, examples of which are also provided in the following description. Exemplary embodiments of the nursing bottle nipple and air-venting system disclosed in the present application are described in detail, although it will be apparent to those skilled in the relevant art that some features that are not particularly important to an understanding of the nursing bottle nipple and air-venting system may not be shown for the sake of clarity.

Furthermore, it should be understood that the nursing bottle nipple and air-venting system disclosed in the present application is not limited to the precise embodiments described below and that various changes and modifications thereof may be effected by one skilled in the art without departing from the spirit or scope of the protection.

It should be noted that throughout the specification and claims herein, when one element is said to be “coupled” or “connected” to another, this does not necessarily mean that one element is fastened, secured, or otherwise attached to another element. Instead, the term “coupled” or “connected” means that one element is either connected directly or indirectly to another element, or is in mechanical or electrical communication with another element.

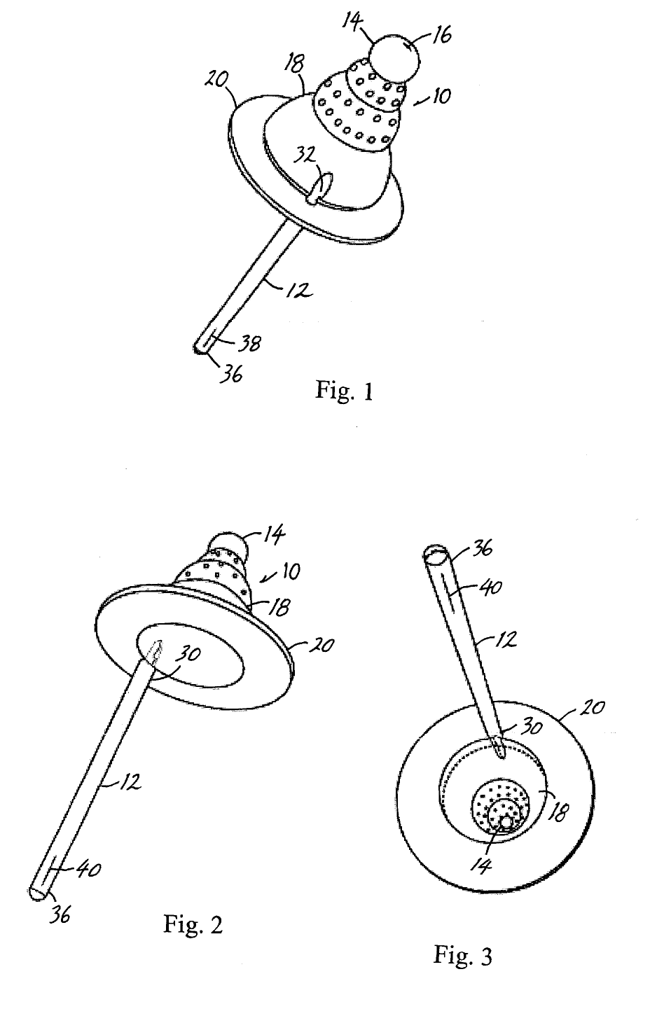

FIG. 1 is a top perspective view of a nipple 10 integrally formed with an air-venting tube 12 according to an embodiment disclosed in the present application. The nipple 10 may have a top nipple portion 14 with an aperture 16 through which fluid such as milk can flow out by a sucking action of an infant. The nipple 10 may have a generally bowl-shaped breast or base portion 18 and an annular flange 20. The nipple 10 and the air-venting tube 12 may be made of rubber, such as silicone rubber, or any other suitable material.

The air-venting tube 12 may extend from the base portion 18 and into a nursing bottle 26, as illustrated in FIG. 6, when the base portion 18 and the annular flange 20 are coupled to the opening of the nursing bottle 26 by means of a collar 44. The air-venting tube 12 may have an upper open end 30 coupled to and in air communication with an air inlet 32 formed on the base portion 18 of the nipple 10. Since the air inlet 32 is located on the base portion 18 of the nipple 10, it cannot be covered by the collar 44 which is employed to hold the nipple 10 to the neck of the nursing bottle 26.

The air-venting tube 12 may have a lower closed end 36 which is normally closed. One or more cuts or slits 38, 40 may be formed at the closed end 36 of the air-venting tube 12. According to the illustrated embodiment, a pair of slits 38, 40 is formed on two opposite sides of the closed end 36 of the air-venting tube 12 respectively.

The pair of slits 38, 40 can be longitudinally extending along the air-venting tube 12. The pair of slits 38, 40 has a length sufficient to permit air to force the pair of slits 38, 40 open and enter the nursing bottle 26, and yet prevent milk from leaking out of the nursing bottle 26 through the pair of slits 38, 40. This prevents the possible leakage of milk from the nursing bottle 26 through the air-venting tube 12 to the air inlet 32. The pair of slits 38, 40 can serve as valves that permit air flow in only one direction, i.e. from the outside of the nursing bottle 26 to the inside of the nursing bottle 26.

Although it has been described that the air-venting tube 12 is integrally formed with the nipple 10, it is understood by one skilled in the art that the nipple 10 and the air-venting tube 12 can be formed separately and then connected together by any appropriate means.

FIGS. 2 and 3 show two different bottom perspective views of the integrated nipple 10 and air-venting tube 12 of FIG. 1. It can be seen that the air-venting tube 12 may extend from a lower end of the base portion 18 adjacent to the annular flange 20. Since the air-venting tube 12 extends from one side of the nipple 10, the air-venting tube 12 would not obstruct the flow of milk from the nursing bottle 26 to the nipple 10.

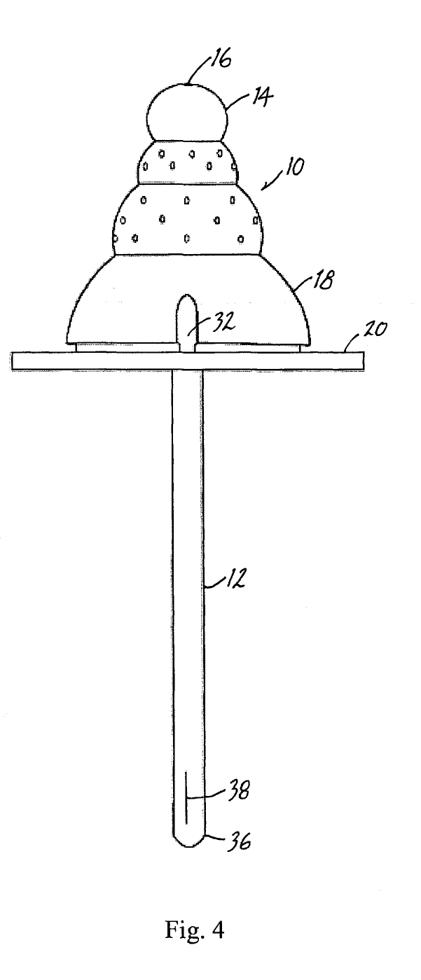

FIG. 4 is a side view of the integrated nipple 10 and air-venting tube 12.

Although it has been shown and described that there are two opposite and longitudinally extending slits 38, 40 provided at the closed end 36 of the air-venting tube 12, it is understood by one skilled in the art that the number, the position, the orientation and the length of the slits may vary so long as the slit(s) can open up and allow only air but not fluid to flow therethrough. For example, the tube 12 may have only one slit. Also, the slit(s) may be formed on the lowermost round tip of the closed end 36 of the air-venting tube 12.

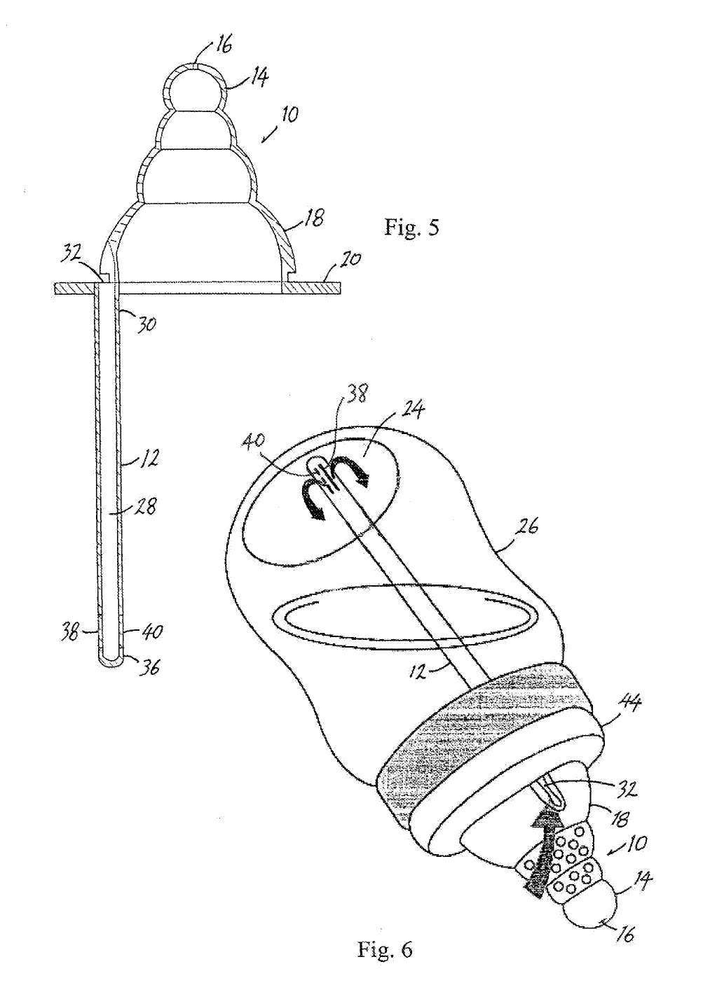

As best illustrated in FIG. 5, the air-venting tube 12 defines an air passage 28 through which air can flow from the outside to the inside of the nursing bottle 26. According to the illustrated embodiment, the air-venting tube 12 may depend generally downwardly and perpendicularly from the nipple 10 towards the bottom 24 of the nursing bottle 26. Accordingly, the air-venting tube 12 may extend towards the bottom 24 of the nursing bottle 26 parallel to a sidewall thereof. The closed end 36 may be located near the bottom 24 of the nursing bottle 26 adjacent to a sidewall thereof.

The air-venting tube 12, the air passage 28 and the pair of slits 38, 40 together form an air-venting system of the nursing bottle 26. This air-venting system allows air to enter the nursing bottle 26 in order to achieve a desired air venting effect. The air-venting tube 12 can ensure that the air is driven into the air inlet 32, along the air passage 28, through the slits 38, 40 and to the bottom 24 of the nursing bottle 26. The air-venting system can also ensure that the air entering the nursing bottle 26 does not mix with the milk inside the nursing bottle 26. This can prevent the infant from swallowing air which has been attributed to colic and spit-up in bottle-feeding infants.

As depicted in FIG. 6, the nursing bottle 26 is normally held in an inverted and tilted position when in use. When an infant begins to suck at the nipple 10, milk flows out of the nursing bottle 26 through the aperture 16 of the nipple 10. As milk flows out of the nursing bottle 26, the pressure of the air at the bottom 24 of the nursing bottle 26 starts to drop. The difference in air pressure between the outside and inside of the nursing bottle 26 forces the pair of slits 38, 40 to open up thereby allowing air to flow from the outside to the inside of the nursing bottle 26. Air is drawn into the air inlet 32, along the air passage 28, through the slits 38, 40 and to the bottom 24 of the nursing bottle 26. As air enters the interior of the nursing bottle 26, the pressures inside and outside the nursing bottle 26 become balanced.

The air-venting system allows an infant to drink milk through the aperture 16 of the nipple 10 easily without requiring the infant to suck vigorously at the nipple 10 thereby preventing the possible onset of otitis media in the infant. Furthermore, the air-venting system allows an infant to drink milk through the aperture 16 of the nipple 10 without causing the formation of air bubbles in the milk inside the nursing bottle 26 thereby preventing spit-up and infantile colic.

When the infant stops sucking at the nipple 10, the slits 38, 40 close up and keep the nursing bottle 26 leak-proof. It is contemplated from the above description that the air venting system disclosed in the present application is an open system. The slits 38, 40 are the openings that allow air to enter the nursing bottle 26. However, liquid such as milk inside the bottle cannot come out.

The air-venting system disclosed in the present application is simple in construction, easy to manufacture and easy to clean.

While the nursing bottle nipple and air-venting system disclosed in the present application has been shown and described with particular references to a number of preferred embodiments thereof, it should be noted that various other changes or modifications may be made without departing from the scope of the protection.

What is claimed is:

1. A nursing bottle having an air-venting system, the nursing bottle comprising:
a container having an opening;
a nipple having a top apertured nipple portion and a generally bowl-shaped base portion adapted to couple to the opening of the container;
an air-venting tube extending from the base portion into the container, the tube having an open end coupled to and in air communication with an air inlet formed on the base portion of the nipple, and an opposite closed end disposed near a bottom of the container; and
at least one slit formed on the air-venting tube at the closed end thereof;
wherein suction on the apertured tip portion of the nipple of the container held in an inverted and tilted nursing position causes a drop of pressure of the air at the bottom of the container, thereby drawing air from the outside of the container, into the air inlet, along the air-venting tube, through the at least one slit, and to the bottom of the container.

2. The nursing bottle as claimed in claim 1, wherein the at least one slit has a length sufficient to permit air to force the at least one slit open and enter the container, and yet prevent liquid from leaking out of the container through the at least one slit.

3. The nursing bottle as claimed in claim 1, wherein the at least one slit extends longitudinally along the air-venting tube.

4. The nursing bottle as claimed in claim 1, comprising two slits.

5. The nursing bottle as claimed in claim 4, wherein the two slits are formed on two opposite sides of the air-venting tube respectively.

6. The nursing bottle as claimed in claim 1, wherein the base portion has an annular flange for engaging with a neck of the container, and the air inlet is formed on the base portion adjacent to the annular flange.

7. The nursing bottle as claimed in claim 1, wherein the air-venting tube extends downwardly from the base portion generally parallel and adjacent to a sidewall of the container.

8. The nursing bottle as claimed in claim 1, wherein the closed end is located near the bottom of the container adjacent to a sidewall thereof.

9. The nursing bottle as claimed in claim 1, wherein the air-venting tube is integrally formed with the nipple.

10. The nursing bottle system as claimed in claim 1, wherein the nipple and the air-venting tube are made of rubber.

11. A nipple for a nursing bottle, the nipple comprising:
a top apertured nipple portion and a generally bowl-shaped base portion adapted to couple to an opening of the nursing bottle;
an air-venting tube adapted to extend from the base portion into the nursing bottle, the tube having an open end coupled to and in air communication with an air inlet formed on the base portion, and an opposite closed end disposed near a bottom of the nursing bottle; and
at least one slit formed on the air-venting tube at the closed end thereof.

12. The nipple as claimed in claim 11, wherein the at least one slit has a length sufficient to permit air to force the at least one slit open and enter the nursing bottle, and yet prevent liquid from leaking out of the container through the at least one slit.

13. The nipple as claimed in claim 11, wherein the at least one slit extends longitudinally along the air-venting tube.

14. The nipple as claimed in claim 11, comprising two slits.

15. The nipple as claimed in claim 14, wherein the two slits are formed on two opposite sides of the air-venting tube respectively.

16. The nipple as claimed in claim 11, wherein the base portion has an annular flange for engaging with a neck of the nursing bottle, and the air inlet is formed on the base portion adjacent to the annular flange.

17. The nipple as claimed in claim 11, wherein the air-venting tube extends downwardly from the base portion generally parallel and adjacent to a sidewall of the nursing bottle.

18. The nipple as claimed in claim 11, wherein the closed end is located near the bottom of the nursing bottle adjacent to a sidewall thereof.

19. The nipple as claimed in claim 11, wherein the air-venting tube is integrally formed with the nipple.

20. The nipple as claimed in claim 11, wherein the nipple and the air-venting tube are made of rubber.
